(19) United States
(12) Patent Application Publication
(10) Pub. No.: US 2007/0270011 A1
(43) Pub. Date: Nov. 22, 2007

(54) Card edge connector

(75) Inventor: Yi-Tse Ho, Tainan Hsien (TW)

Correspondence Address: MOLEX INCORPORATED, 2222 WELLINGTON COURT, LISLE, IL, 60532, US

(73) Assignee: MOLEX INCORPORATED, Lisle (US)

(21) Appl. No.: 11/801,253

(22) Filed: May 8, 2007

(30) Foreign Application Priority Data
May 9, 2006 (TW) 95207923

(51) Int. Cl. H01R 13/62

(52) U.S. Cl. 439/262

(57) ABSTRACT

A card edge connector that allows the insertion of an electric card includes an insulating body, a plurality of terminals, and two metallic pieces. Each of the two metallic pieces includes a substrate fixedly provided on both sides of the insulating body, an elastic arm connected to the substrate, and a supporting portion having a supporting plate with a supporting surface facing upwardly. The lower edge of the supporting plate is connected to the lower edge of the elastic arm. The present invention uses the supporting portion of the metallic piece to block and support the electric card, thereby preventing the electric card from being displaced downwardly and vibrating. Further, the supporting portion is formed on the elastic arm with good elasticity and is not prone to deformation and damage. Further, the supporting portion restricts outward displacement.

### FIELD OF THE INVENTION

The present invention relates to a card edge connector, and in particular to a card edge connector provided on the upper surface of a circuit board that allows an electric card to be inserted therein.

### BACKGROUND OF THE INVENTION

A conventional card edge connector is provided on the upper surface of a circuit board and allows an electric card to be inserted therein, thereby electrically connecting the circuit board and the electric card. Taiwan Patent Publication No. 382836 (Application No. 86118731) published on Feb. 21, 2000 discloses an electrical connector having a metallic latch, which includes a dielectric casing and a latching element having a latch piece. The latch piece of the latching element can be locked to the upper surface of the electric card, thereby preventing an upward bound of the electric card. In this way, the electric card can be inserted on the dielectric casing stably.

Although the above card edge connector is provided with the latch piece for locking the electric card, the latch piece can be only used to prevent the upward bound of the electric card. However, it cannot prevent the downward displacement of the electric card. Therefore, the electric card is not well supported and is prone to vibrate, causing the stability of the electric card to become poor. Thus, the card edge connector is provided in the latching element with an inwardly extending horizontal plate, thereby supporting the electric card to prevent the electric card from vibrating. Via the above arrangement, the stability of the electric card becomes better.

However, the plate formed roughly on the latching element is weak and thus prone to deformation and damage. Therefore, the electric card cannot be supported efficiently, and the problem of poor stability of the electric card still exists. Furthermore, the plate only has the one purpose of supporting the electric card and does not provide any other functions. The proposed invention overcomes the above problems.

### SUMMARY OF THE INVENTION

The primary object of the present invention is to provide a card edge connector that prevents the electric card from being displaced downwardly and vibrating. Therefore, the stability of the electric card is improved. Further, the metallic piece can be prevented from being over-turned outwardly and permanent deforming, thereby having a function of restricting outward displacement.

In order to achieve the above object, the present invention provides a card edge connector, which includes an insulating body having an insertion slot; a plurality of terminals provided on the upper and lower edges of the insertion slot of the insulating body, each terminal having a contact portion and a tail portion, the contact portion being located in the insertion slot, the tail portion extending beyond the insulating body; and two metallic pieces. Each metallic piece comprises a substrate fixedly provided on both sides of the insulating body; an elastic arm connected to the substrate, the front end of the elastic arm being formed with a free end; and a supporting portion having a supporting plate with a supporting surface facing upward. The lower edge of the supporting plate is connected to the lower edge of the elastic arm.

The advantages of the present invention lies in that, the supporting portion of the metallic piece is used to block and support the electric card, thereby preventing the electric card from being displaced downwardly and vibrating. As a result, the stability of the electric card is better. Thus, the electrical connection between the electric card and the card edge connector can be firmly assured, thereby obtaining better electrical properties. Furthermore, the supporting portion is formed on the elastic arm with good elasticity and high strength, so that it is not prone to deformation and damage, thereby supporting the electric card efficiently. Further, when the elastic arm of the metallic piece is over-turned outwardly, the supporting portion can abut against the inner edge of the substrate, thereby restricting outward displacement.

In order to better understand the characteristics and technical contents of the present invention, a detailed description thereof will be made with reference to the accompanying drawings. However, it should be understood that the drawings and the description are illustrative but not used to limit the scope of the present invention.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is an exploded perspective view showing the card edge connector of the present invention, an electric card and a circuit board;

FIG. 2 is an exploded perspective view taken from another viewing angle and showing the card edge connector of the present invention, an electric card and a circuit board;

FIG. 3 is an assembled perspective view showing the card edge connector of the present invention, an electric card and a circuit board;

FIG. 4 is a front showing a portion of the card edge connector of the present invention, an electric card and a circuit board; and

FIG. 5 is a perspective view of the metallic piece of the present invention.

### DETAILED DESCRIPTION OF EMBODIMENTS

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

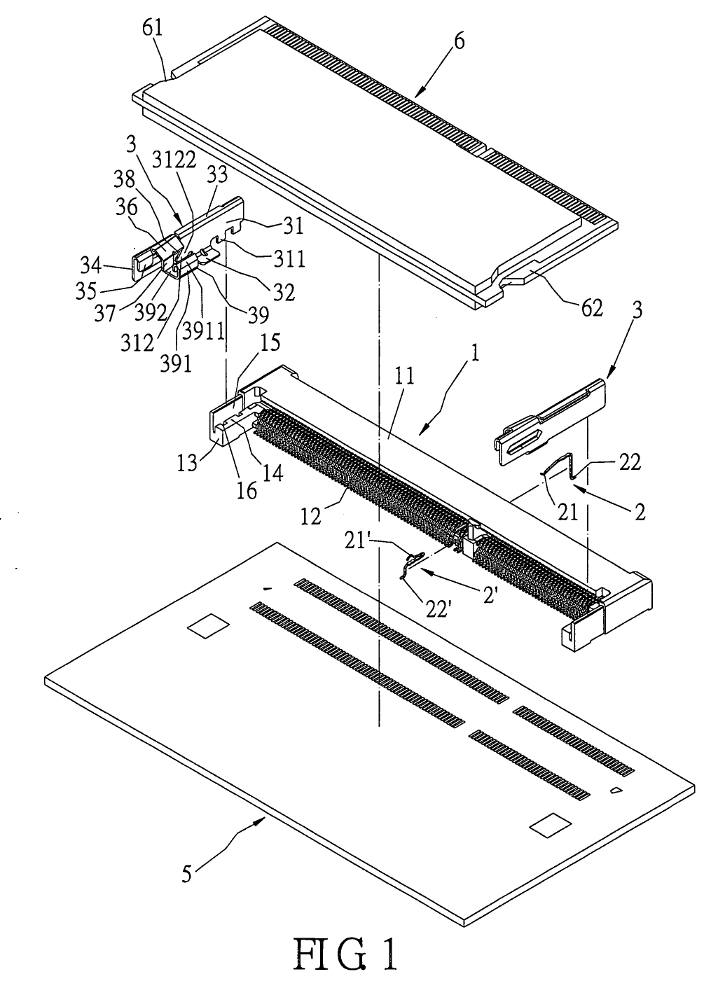

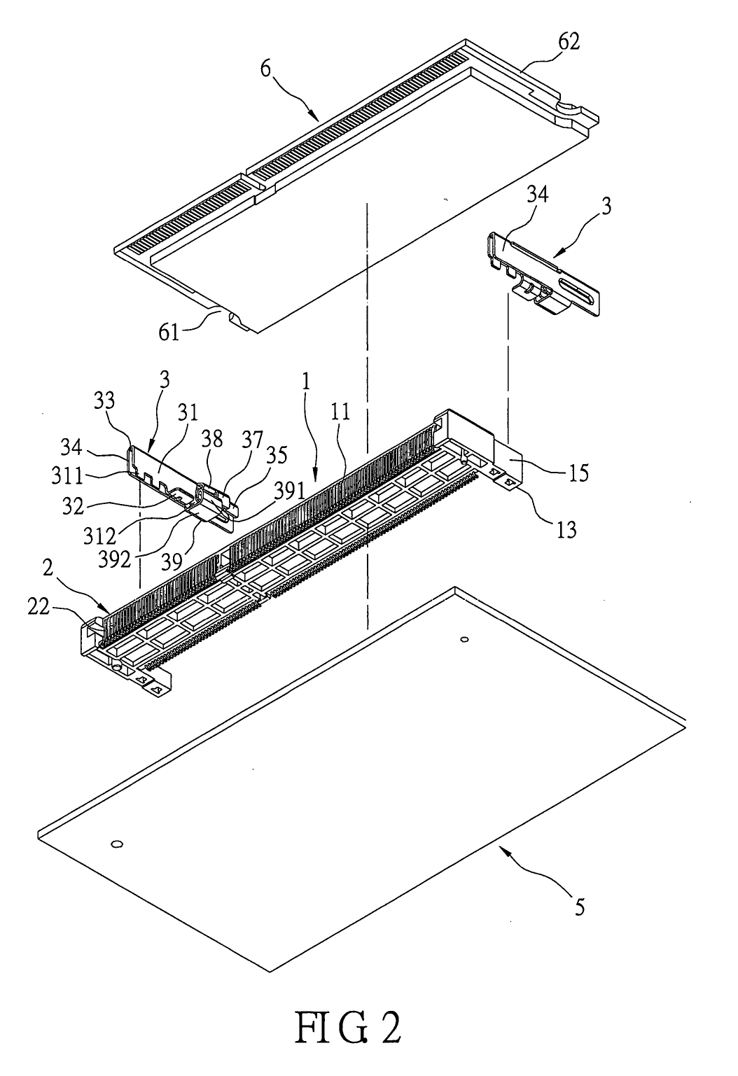

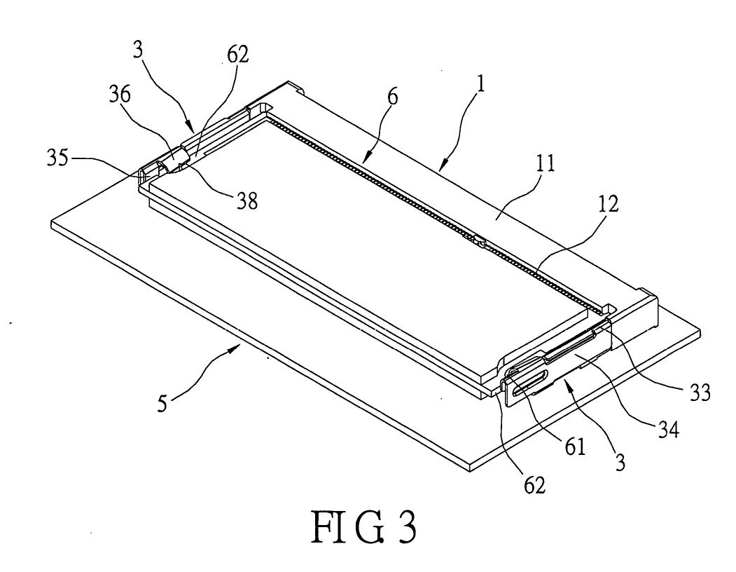

Please refer to FIGS. 1 to 3, in which the present invention of a card edge connector is shown. The card edge connector is provided on an upper surface of a circuit board 5 and allows an electric card 6 to be inserted therein, thereby electrically connecting the circuit board 5 and the electric card 6. The card edge connector comprises an insulating body 1, a plurality of terminals 2, 2′ and two metallic pieces 3. The insulating body 1 is made of plastic materials and has a body portion 11. The body portion 11 is provided thereon with an elongate insertion slot 12 that allows the electric card 6 to be inserted therein. A fixing block 13 extends from both sides of the body portion 11 respectively. The two fixing blocks 13 are blocks protruding from the front side of the body portion 11. Each of the two fixing blocks 13 is formed thereon with a platen portion 14 and an outer sidewall 15 along the extending direction thereof. The platen portion 14 allows the electric card 6 to be disposed thereon. The two fixing blocks 13 are provided with two insertion holes 16 that allow the metallic piece 3 to be inserted therein and fixed thereto.

The terminals 2, 2′ are provided on the body portion 11 of the insulating body 1. The terminals 2, 2′ are provided in an upper row and a lower row that are provided on the upper and lower edges of the insertion slot 12 respectively. Each of the terminals 2, 2′ has a contacting portion 21, 21′ and a tail portion 22, 22′. The contacting portion 21, 21′ is located within the insertion slot 12 for electrically contacting the electrical contacts of the electric card 6. The tail portion 22, 22′ extends beyond the body portion 11 for electrically connecting with the electrical contacts of the circuit board 5.

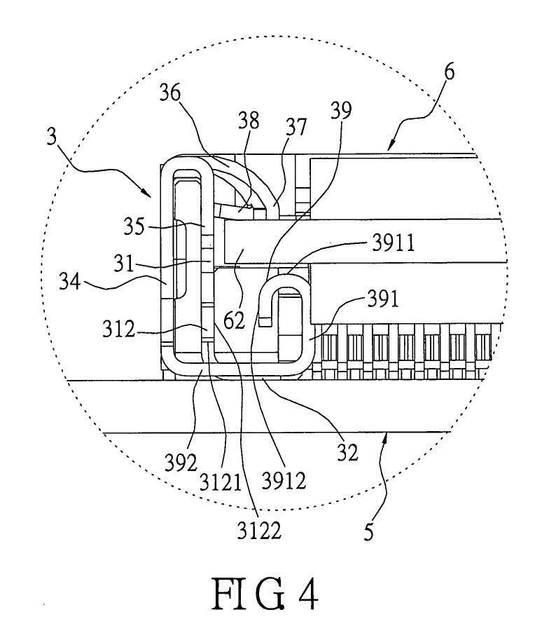

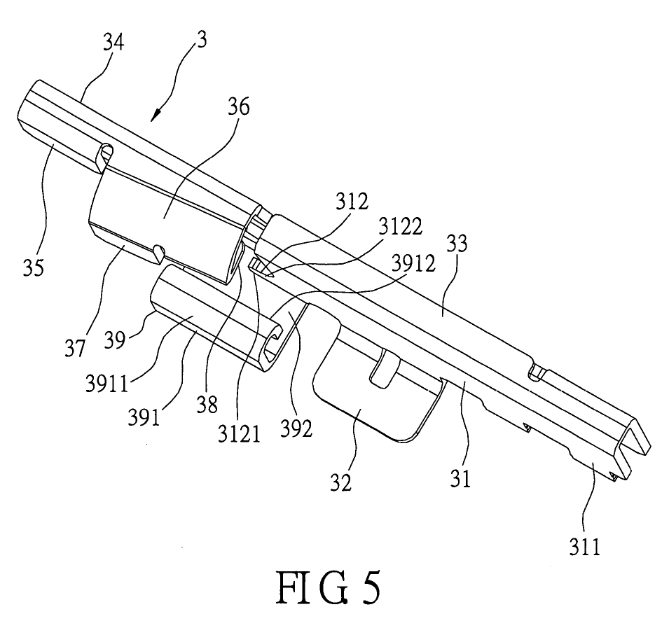

The two metallic pieces 3 are made of metallic materials by means of pressing. From an upper position, the two metallic pieces 3 are mounted downwardly on the two fixing blocks 13. Each of the two metallic pieces 3 has a substrate 31, a welded portion 32, a top plate 33, an elastic arm 34, a turning portion 35, a guiding portion 36, an engaging portion 37, a locking portion 38 and a supporting portion 39, as shown in FIGS. 4 and 5. The substrate 31 is an upright plate and is provided on the inside of the outer sidewall 15 of the insulating body 1. The lower edge of the substrate 31 extends downwardly to form two insertion pieces 311 that are fixedly inserted into the two corresponding insertion holes 16 of the insulating body 1, thereby mounting the two metallic pieces 3 on the insulating body 1 stably. The inner edge of the substrate 31 is used to abut the supporting portion 39. In the present embodiment, the substrate 31 is provided with an abutting portion 312 for abutting the supporting portion 39.

The welded portion 32 extends horizontally and inwardly from the lower edge of the substrate 31. The welded portion 32 can be welded and fixed on the circuit bard 5 to electrically connect the metallic piece 3 with the circuit board 5. The top plate 33 extends from the upper edge of the substrate 31 horizontally and outwardly. The top plate 33 is an elongated plate.

The elastic arm 34 extends downwardly and forwardly from the outer edge of the top plate 33 and is positioned near the rear end thereof. The elastic arm 34 is connected to the substrate 31 via the top plate 33. The elastic arm 34 is an elongated upright plate. The front end of the elastic arm 34 is formed into a free end and is provided on the outside of the outer sidewall 15 of the insulating body 1. The free end of the elastic arm 34 protrudes from the front end of the fixing block 13 of the insulating body 1 by a proper length.

The turning portion 35 and the guiding portion 36 extend inwardly and downwardly from the free end of the elastic arm 34. The turning portion 35 helps to turn the elastic arm 34 to move outwardly so that the engaging portion 37 and the locking portion 38 can be detached from the electric card 6, thereby ejecting the electric card 6 smoothly. The guiding portion 36 is located behind the turning portion 35 and is bent into a curved shape so as to guide the electric card 6 to be pressed into position.

The engaging portion 37 is an upright plate. The upper edge of the engaging portion 37 is connected to the upper edge of the free end of the elastic arm 34. The engaging portion 37 can be used to engage with corresponding notches 61 of both sides of the electric card 6 so that the electric card 6 cannot move forwards or backwards. The locking portion 38 extends from the lower edge of the guiding portion 36. The locking portion 38 is located behind the engaging portion 37. The locking portion 38 is a bent curved plate so as to be press-fitted on the upper surface of the electric card 6.

The supporting portion 39 bends and extends inwardly from the lower edge of the elastic arm 34, and comprises a supporting plate 391. The supporting plate 391 is an upright plate. The upper end of the supporting plate 391 is formed into an inverted-U shape and has a supporting surface 3911 facing upwardly. The upper end of the supporting plate 391 further has an outer edge 3912 facing outwardly. The lower edge of the supporting plate 391 has a horizontal connecting plate 392 that is connected to the lower edge of the elastic arm 34. The connecting plate 392 is located below the abutting portion 312 with a proper interval therebetween. The supporting plate 391 is located on the inside of the abutting portion 312 with a proper interval therebetween. The supporting portion 39 is used to block the electric card 6. Via the above structure, the card edge connector of the present invention is formed.

The card edge connector of the present invention can be provided on the circuit board 5 and allows the electric card 6 to be inserted into the insulating body 1 so that the electrical contacts of the electric card 6 can be electrically connected with the circuit board 5 via the terminals 2, 2′ within the insertion slot 12. When the electric card 6 is inserted into the insulating body 1, the engaging portions 37 of the two metallic pieces 3 engage with the notches 61 of the electric card 6, thereby blocking the electric card 6 from moving forwards or backwards and preventing the electric card 6 becoming detached from the insertion slot 12. The locking portions 38 of the two metallic pieces 3 are press-fitted to the upper surface of the plate 62 of the electric card 6, thereby stabilizing the insertion of the electric card 6. The supporting portions 39 of the two metallic pieces 3 are used to block the lower surface of the plate body 62 of the electric card 6, thereby preventing the electric card 6 from being displaced downwardly.

When the electric card 6 is to be removed, the turning portions 35 of the two metallic pieces 3 are used to turn the elastic arms 34 to move outwardly, so that the engaging portions 37 are detached from the notches 61 of both sides of the electric card 6. At the same time, the locking portions 38 are detached from the electric card 6, thereby allowing the electric card 6 to be removed easily. When the elastic arm 34 of the metallic piece 3 is over-turned outwardly, the outer edge 3912 of the supporting portion 39 can abut against the inner edge 3122 of the abutting portion 312 on the substrate 31, thereby restricting outward displacement to prevent the elastic arm 34 from a permanent deforming or failure.

The advantage of the present invention lies in that, the supporting surface 3911 of the supporting portion 39 of the metallic piece 3 blocks and supports the electric card 6, thereby preventing the electric card 6 from being displaced downwardly and vibrating. As a result, the stability of the electric card 6 is better, thereby assuring the electrical connection between the electric card and the card edge connector firmly and obtaining better electrical properties.

Further, the supporting portion 39 of the present invention is formed on the elastic arm 34 with good elasticity and high strength, and thus is not prone to deformation or damage. Therefore, the electric card can be supported efficiently to achieve better stability. Furthermore, when the elastic arm 34 of the metallic piece 3 is over-turned outwardly, the outer edge 3912 of the supporting plate 391 of the supporting portion 39 abuts against the inner edge 3122 of the abutting portion 312 of the substrate 31, thereby restricting outward displacement.

Further, when the electric card 6 generates an upward bound unexpectedly, the electric card 6 pushes the locking portions 38 of the two metallic pieces 3 immediately to drive the elastic arms 34 and the supporting portions 39 to move upwardly. At this time, the connecting plate 392 abuts and blocks the bottom 3121 of the abutting portion 312, thereby restricting upward displacement and avoiding the upward bound of the electric card 6.

Although the present invention has been described with reference to the foregoing preferred embodiment, it will be understood that the invention is not limited to the details thereof. Various equivalent variations and modifications may occur to those skilled in this art in view of the teachings of the present invention. Thus, all such variations and equivalent modifications are also embraced within the scope of the invention as defined in the appended claims.

While a preferred embodiment of the invention is shown and described, it is envisioned that those skilled in the art may devise various modifications without departing from the spirit and scope of the foregoing description and the appended claims.

What is claimed is:

1. A card edge connector, comprising:
an insulating body having an insertion slot;
a plurality of terminals provided on the insertion slot of the insulating body, each terminal having a contacting portion and a tail portion, the contact portion being located in the insertion slot, the tail portion extending beyond the insulating body; and
two metallic pieces each comprising a substrate fixedly provided on both sides of the insulating body, an elastic arm connected to the substrate, the front end of the elastic arm being formed into a free end, and a supporting portion having a supporting plate with a supporting surface facing upwardly, the lower edge of the supporting plate being connected to the lower edge of the elastic arm.

2. The card edge connector according to claim 1, wherein both sides of the insulating body are provided with a fixing block respectively, and the substrates of the two metallic pieces are fixedly provided on the fixing blocks of both sides of the insulating body.

3. The card edge connector according to claim 2, wherein insertion pieces extend downwardly from the lower edge of the substrate of the two metallic pieces, the two fixing blocks of the insulating body are provided with corresponding insertion holes, and the insertion pieces are inserted and fixed into the corresponding insertion holes of the fixing blocks.

4. The card edge connector according to claim 1, wherein the substrate of the two metallic pieces is provided with an abutting portion, the supporting plate is located in the inside interval of the abutting portion.

5. The card edge connector according to claim 1, wherein the supporting portion of the two metallic pieces further has a connecting plate, the connecting plate is connected to the lower edge of the elastic arm and the lower edge of the supporting plate.

6. The card edge connector according to claim 1, wherein the upper end of the supporting plate of the two metallic pieces is bent and has an outer edge facing outwardly.

7. The card edge connector according to claim 1, wherein the substrate of the two metallic pieces is provided with an abutting portion, the supporting plate is located in the inside interval of the abutting portion, the supporting portion of the two metallic pieces further has a connecting plate, the connecting plate is connected to the lower edge of the elastic arm and the lower edge of the supporting plate, the connecting plate is located in the interval below the abutting portion.

8. The card edge connector according to claim 1, wherein each of the two metallic pieces has a welding portion, and the welding portion is formed by means of extending from the lower edge of the substrate.

9. The card edge connector according to claim 1, wherein each of the two metallic pieces has a top plate, the top plate is formed by means of extending outwardly from the upper edge of the substrate, and the elastic arm is formed by means of extending downwardly and forwardly from the outer edge of the top plate and is positioned near the rear end thereof.

10. The card edge connector according to claim 1, wherein each of the two metallic pieces has a turning portion, and the turning portion is formed by means of extending inwardly and downwardly from the free end of the elastic arm.

11. The card edge connector according to claim 1, wherein each of the two metallic pieces has a guiding portion formed by means of extending inwardly and downwardly from the upper edge of the free end of the elastic arm, and a locking portion connected to the lower edge of the guiding portion.

12. The card edge connector according to claim 1, wherein each of the two metallic pieces has an engaging portion, the engaging portion is an upright plate, and the upper edge of the engaging portion is connected to the upper edge of the free end of the elastic arm.

13. The card edge connector according to claim 1, wherein the terminals are provided on upper and lower edges of the insertion slot.

14. The card edge connector according to claim 1, wherein the supporting portion prevents an electric card installed in the card edge connector from being displaced in a direction below the supporting portion.

15. The card edge connector according to claim 1, wherein the metallic pieces include a locking portion extending from the elastic arm to prevent an electric card installed in the card edge connector from being displaced in a direction above the locking portion.

16. The card edge connector according to claim 14, wherein the metallic pieces include a locking portion extending from the elastic arm to prevent an electric card installed in the card edge connector from being displaced in a direction above the locking portion.

17. The card edge connector according to claim 1, wherein the terminals are provided on upper and lower edges of the insertion slot.
